(19) United States
(12) Patent Application Publication
(10) Pub. No.: US 2022/0258618 A1
(43) Pub. Date: Aug. 18, 2022

(54) BRAKING CONTROL DEVICE

(71) Applicants: DENSO CORPORATION, Kariya-city (JP); TOYOTA JIDOSHA KABUSHIKI KAISHA, Toyota-shi (JP)

(72) Inventors: Masakatsu SHIGYOH, Kariya-city (JP); Takashi SATOU, Kariya-city (JP); Takuto SUZUKI, Kariya-city (JP); Kensuke UEDA, Kariya-city (JP); Yoshitaka FUJITA, Toyota-shi (JP); Tomohiro YAMASHITA, Toyota-shi (JP); Masao YANO, Kariya-shi (JP); Sota UKAI, Kariya-shi (JP)

(73) Assignees: DENSO CORPORATION, Kariya-city (JP); TOYOTA JIDOSHA KABUSHIKI KAISHA, Toyota-shi (JP)

(21) Appl. No.: 17/735,376

(22) Filed: May 3, 2022

(30) Foreign Application Priority Data
Nov. 7, 2019 (JP) 2019-202654

(51) Int. Cl. B60L 15/20; B60T 8/32; B60W 10/06; B60W 10/188

(52) U.S. Cl. CPC B60L 15/2009; B60T 8/329; B60W 10/06; B60W 10/188; B60T 2250/04; B60T 2260/09; B60W 2710/182; B60L 2240/423; B60L 2240/14; B60L 2240/421; B60L 2240/46; B60W 2710/083; B60T 2250/03

(57) ABSTRACT

The motor control unit reduces the drive braking torque for applying the braking force to the drive wheel by the reverse rotation timing predicted by the reverse rotation prediction unit at the latest, and the friction braking unit increases a friction braking force applied to the drive wheel by the friction braking device so that the friction braking force exceeds the braking force provided by the drive braking torque by the reverse rotation timing predicted by the reverse rotation prediction unit at the latest.

### CROSS-REFERENCE TO RELATED APPLICATION

The present application is a continuation application of International Application No. PCT/JP2020/041151, filed on Nov. 4, 2020, which claims priority to Japanese Patent Application No. 2019-202654, filed in Japan on Nov. 7, 2019.

The contents of these applications are incorporated herein by reference in their entirety.

### BACKGROUND

### 1. Technical Field

The present disclosure relates to a braking control device.

### 2. Related Art

A braking device is known that carries out braking by a friction brake in addition to the braking by an electric motor. When the brake pedal is depressed and the wheel rotation speed is equal to or higher than a predetermined speed, the braking device carries out braking by the electric motor, whereas, when the wheel rotation speed becomes lower than the predetermined speed, the braking device carries out braking by the friction brake instead of braking by the electric motor.

### SUMMARY

The present disclosure provides a braking control device. As an aspect of the present disclosure, a braking control device includes at least a motor control unit, an acceleration detection unit, a rotation speed detection unit, a reverse rotation prediction unit, and a friction braking unit. The motor control unit causes an electric motor connected to a drive wheel of a vehicle to generate a drive braking torque for applying a drive force or braking force to the drive wheel. The acceleration detection unit detects an acceleration of the vehicle. The rotation speed detection unit detects a rotation speed of the electric motor. The reverse rotation prediction unit uses the acceleration detected by the acceleration detection unit and the rotation speed detected by the rotation speed detection unit to predict a reverse rotation timing at which the drive wheel will rotate backward before the vehicle stops. The friction braking unit controls a friction braking device provided for the drive wheel. The motor control unit reduces the drive braking torque for applying the braking force to the drive wheel by the reverse rotation timing predicted by the reverse rotation prediction unit at the latest. The friction braking unit increases a friction braking force applied to the drive wheel by the friction braking device so that the friction braking force exceeds the braking force provided by the drive braking torque by the reverse rotation timing predicted by the reverse rotation prediction unit at the latest.

### BRIEF DESCRIPTION OF THE DRAWINGS

In the accompanying drawings:

FIG. 1 is a view showing the general configuration of a vehicle according to the present embodiment;

FIG. 2 is a diagram illustrating how signals are transmitted/received in FIG. 1;

FIG. 3 is a flowchart illustrating a control flow of FIG. 1; and

FIG. 4 is a timing chart.

### DETAILED DESCRIPTION OF THE PREFERRED EMBODIMENTS

In JP 2000-134715 A (published unexamined patent application), braking by the friction brake is performed instead of braking by the electric motor when the wheel rotation speed becomes lower than the predetermined speed, and the control does not reflect the road conditions. For example, on a low friction road, there may be a delay in switching to the friction brake, and the drive wheels may reverse before stopping. If switching to the friction brake is performed earlier in order to avoid the reversal of the drive wheels, it may not be possible to secure a sufficient amount of regenerative power generated by the electric motor.

One or more aspects of the present disclosure are directed to provide a braking control device that can suppress the reversal of drive wheels and at the same time secure a sufficient amount of regenerative electric power according to the road conditions.

The present disclosure is a braking control device including: a motor control unit that causes an electric motor connected to a drive wheel of a vehicle to generate a drive braking torque for applying a drive force or braking force to the drive wheel; an acceleration detection unit that detects an acceleration of the vehicle; a rotation speed detection unit that detects a rotation speed of the electric motor; a reverse rotation prediction unit that uses the acceleration detected by the acceleration detection unit and the rotation speed detected by the rotation speed detection unit to predict a reverse rotation timing at which the drive wheel will rotate backward before the vehicle stops; and a friction braking unit that controls a friction braking device provided for the drive wheel, characterized in that the motor control unit reduces the drive braking torque for applying the braking force to the drive wheel by the reverse rotation timing predicted by the reverse rotation prediction unit at the latest, and the friction braking unit increases a friction braking force applied to the drive wheel by the friction braking device so that the friction braking force exceeds the braking force provided by the drive braking torque by the reverse rotation timing predicted by the reverse rotation prediction unit at the latest.

In the present disclosure, since the reverse rotation prediction unit predicts the reverse rotation timing based on the acceleration of the vehicle and the rotation speed of the electric motor, the generation of the braking force by the electric motor can be continued until a time that is no later than the reverse rotation timing and as close as possible to the reverse rotation timing, reflecting the influence of the road surface conditions. This contributes to securing a sufficient amount of regenerative power. Since the friction braking force is increased while reducing the braking force provided by the electric motor so that the friction braking force exceeds the braking force provided by the electric motor by the reverse rotation timing, the drive wheel can be braked without rotating backward regardless of the road surface conditions.

The present embodiment will be described with reference to the drawings. In the drawings, to facilitate understanding of the description, the same components are denoted by the same reference numbers when possible, and they will not be explained repeatedly.

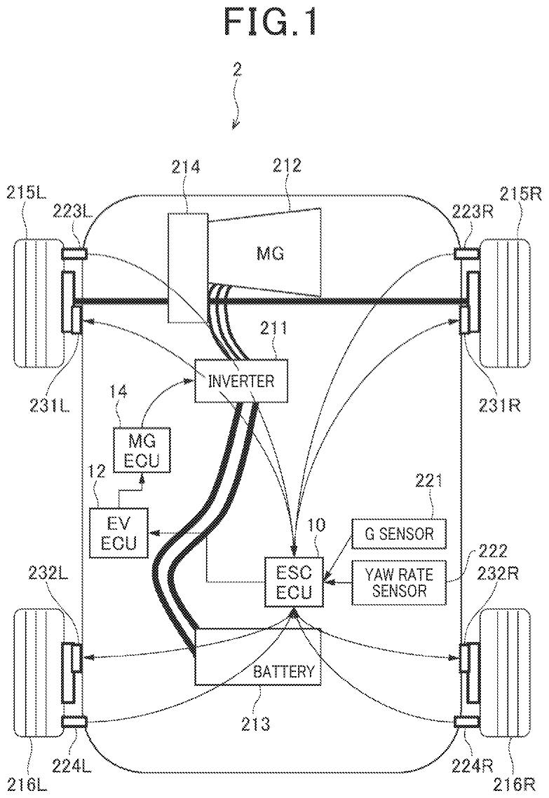

As shown in FIG. 1, a vehicle 2 is provided with a right front wheel 215R and a left front wheel 215L, and a right rear wheel 216R and a left rear wheel 216L. The right and left front wheels 215R and 215L function as driving wheels for driving the vehicle 2. The right and left rear wheels 216R and 216L function as driven wheels that rotate when the right and left front wheels 215R and 215L are driven.

The vehicle 2 is provided with an inverter 211, a motor generator 212, a battery 213, and a differential gear 214. The inverter 211 is provided between the motor generator 212 and the battery 213. When the motor generator 212 is driven by using the electric power stored in the battery 213, the inverter 211 converts the direct current output from the battery 213 into a three-phase alternating current and supplies it to the motor generator 212. When regenerative braking is performed using the motor generator 212 as a generator, the inverter 211 converts the three-phase alternating current output from the motor generator 212 into a direct current and supplies it to the battery 213.

The motor generator 212 is a motor generator that serves both as a motor and a generator. The motor generator 212 is connected to the right and left front wheels 215R and 215L which are the drive wheels via a differential gear 214. When a three-phase alternating current is supplied from the inverter 211, the motor generator 212 rotates according to the supplied three-phase alternating current and drives the right and left front wheels 215R and 215L via the differential gear 214. When regenerative braking is performed, the rotation of the right and left front wheels 215R and 215L are transmitted to the motor generator 212 via the differential gear 214. When the battery 213 is rechargeable, power is generated by the shaft rotation of the motor generator 212, and the generated three-phase alternating current is converted into a direct current by the inverter 211 and supplied to the battery 213.

The vehicle 2 is provided with an Electronic Stability Control-Electronic Control Unit (ESC-ECU) 10, an Electric Vehicle-Electronic Control Unit (EV-ECU) 12, and a Motor Generator-Electronic Control Unit (MG-ECU) 14.

The ESC-ECU 10 is a device for stabilizing the behavior of the vehicle 2. The ESC-ECU 10 receives detection signals from a G sensor 221, yaw rate sensor 222, right front wheel speed sensor 223R, left front wheel speed sensor 223L, right rear wheel speed sensor 224R, and left rear wheel speed sensor 224L.

The G sensor 221 is a sensor for measuring the acceleration when the vehicle 2 is accelerating and decelerating. The G sensor 221 outputs a signal indicating the acceleration when the vehicle 2 is accelerating and decelerating in the front-rear direction to the ESC-ECU 10. The yaw rate sensor 222 is a sensor for measuring the angular velocity of the vehicle 2 around the vertical axis. The yaw rate sensor 222 outputs a signal indicating the angular velocity around the vertical axis of the vehicle 2 to the ESC-ECU 10.

The right front wheel speed sensor 223R is a sensor for measuring the wheel speed of the right front wheel 215R. The right front wheel speed sensor 223R outputs a signal indicating the wheel speed of the right front wheel 215R to the ESC-ECU 10.

The left front wheel speed sensor 223L is a sensor for measuring the wheel speed of the left front wheel 215L. The left front wheel speed sensor 223L outputs a signal indicating the wheel speed of the left front wheel 215L to the ESC-ECU 10.

The right rear wheel speed sensor 224R is a sensor for measuring the wheel speed of the right rear wheel 216R. The right rear wheel speed sensor 224R outputs a signal indicating the wheel speed of the right rear wheel 216R to the ESC-ECU 10.

The left rear wheel speed sensor 224L is a sensor for measuring the wheel speed of the left rear wheel 216L. The left rear wheel speed sensor 224L outputs a signal indicating the wheel speed of the left rear wheel 216L to the ESC-ECU 10.

The ESC-ECU 10 performs computation for stabilizing the behavior of the vehicle 2 based on the signals input from the G sensor 221, yaw rate sensor 222, right front wheel speed sensor 223R, left front wheel speed sensor 223L, right rear wheel speed sensor 224R, and left rear wheel speed sensor 224L. The ESC-ECU 10 outputs a signal for adjusting the vehicle body speed of the vehicle 2 to the EV-ECU 12 based on the computation results. The ESC-ECU 10 outputs signals for performing friction braking to a right front friction brake 231R, left front friction brake 231L, right rear friction brake 232R, and left rear friction brake 232L as friction braking devices based on the computation results.

The EV-ECU 12 outputs to the MG-ECU 14 a torque corresponding to the rotation speed to be produced by the motor generator 212 based on the information on the vehicle body speed output from the ESC-ECU 10, the rotation speed of the motor generator 212 output from the MG-ECU 14, and information indicated by the driver's operation, such as the accelerator position, and signals output from various sensors (not shown).

The MG-ECU 14 outputs a control signal to the inverter 211 so that the motor generator 212 generates a certain torque. The MG-ECU 14 measures the rotation speed of the motor generator 212. The MG-ECU 14 outputs information indicating the rotation speed of the motor generator 212 to the EV-ECU 12.

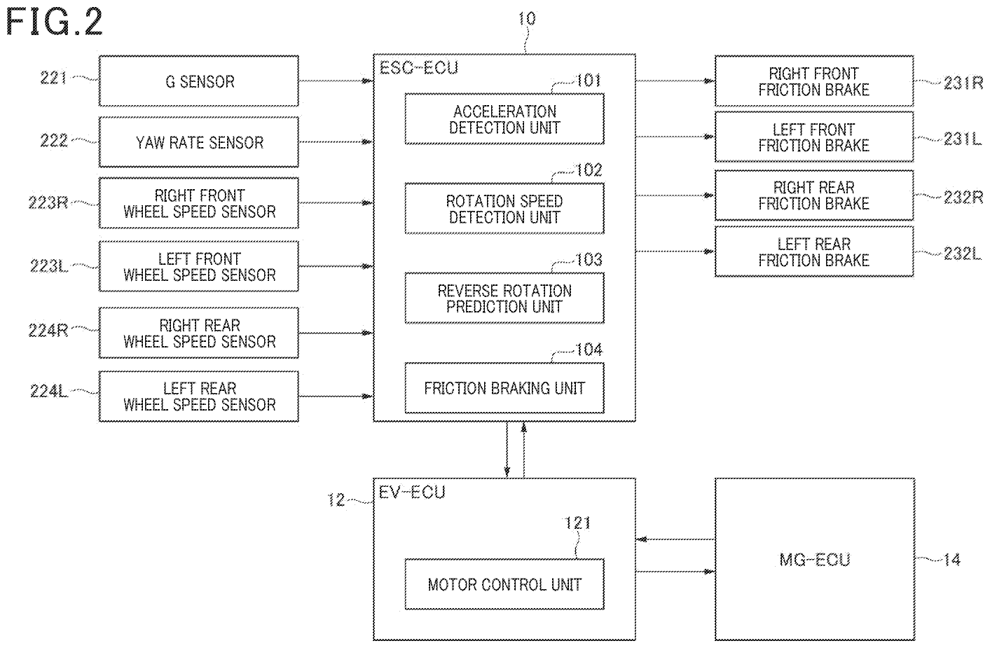

Next, the functional elements of the ESC-ECU 10, EV-ECU 12, and MG-ECU 14 will be described with reference to FIG. 2. As shown in FIG. 2, the ESC-ECU 10 includes an acceleration detection unit 101, rotation speed detection unit 102, reverse rotation prediction unit 103, and friction braking unit 104 as functional components.

The acceleration detection unit 101 detects the acceleration of the vehicle 2. The acceleration of the vehicle 2 can be acquired by the output signal of the G sensor 221.

The rotation speed detection unit 102 detects the rotation speed of the motor generator 212 which is an electric motor. The MG-ECU 14 measures the rotation speed of the motor generator 212 and output it to the EV-ECU 12. The rotation speed detection unit 102 receives information on the rotation speed of the motor generator 212 from the EV-ECU 12.

The reverse rotation prediction unit 103 uses the acceleration detected by the acceleration detection unit 101 and the rotation speed detected by the rotation speed detection unit 102 to predict the reverse rotation timing at which the motor generator 212, which is an electric motor, rotates backward before the vehicle 2 stops.

The friction braking unit 104 controls the right and left front friction brakes 231R and 231L as friction braking devices provided for the right and left front wheels 215R and 215L which are drive wheels.

The EV-ECU 12 includes a motor control unit 121 as a functional component. The motor control unit 121 is a part for generating a drive braking torque for providing a drive force or braking force from the motor generator 212, which is an electric motor connected to the right and left front drive wheels 215R and 215L of the vehicle 2, to the right and left front drive wheels 215R and 215L.

The motor control unit 121 collects information output from sensors that detect the driver's operation, such as the accelerator position, and other various sensors, information output from the ESC-ECU 10, and information output from the MG-ECU 14, determines the required torque for the motor generator 212, and outputs it to the MG-ECU 14.

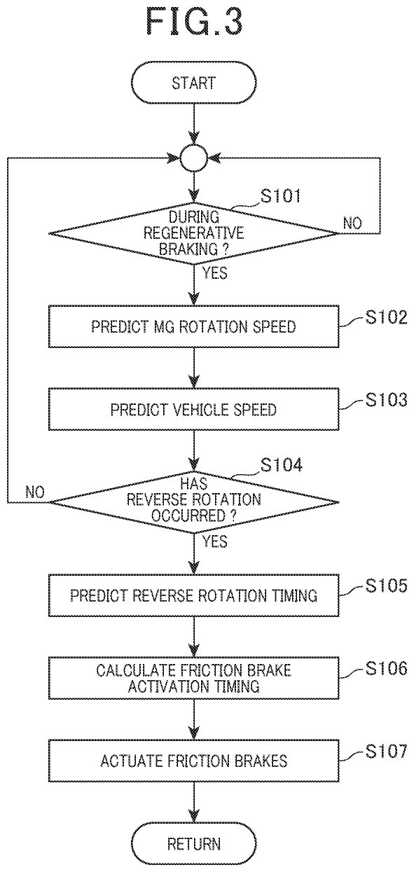

Next, the specific control will be described with reference to FIG. 3. In step S101, the motor control unit 121 determines whether braking torque is being generated by the motor generator 212 and regenerative braking is being performed. When regenerative braking is being performed, the process proceeds to step S102, and when regenerative braking is not being performed, step S101 is repeated.

In step S102, the reverse rotation prediction unit 103 predicts the rotation speed of the motor generator 212. The reverse rotation prediction unit 103 predicts the rotation speed of the motor generator 212 based on the detection result of the rotation speed detection unit 102.

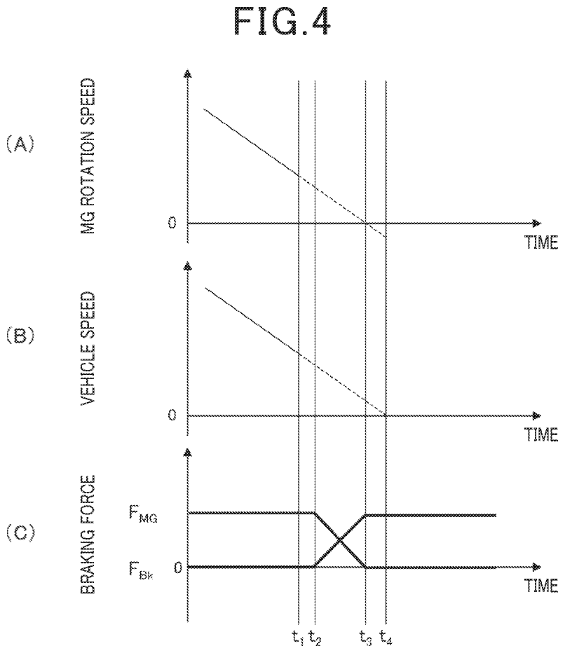

FIG. 4 shows an example of how the rotation speed of the motor generator 212 changes, an example of how the speed of the vehicle 2 changes, and an example of how the braking force changes. FIG. 4(A) shows predicted values of the rotation speed of the motor generator 212 up to time t1 and the rotation speed thereof from time t1 onwards. FIG. 4(B) shows predicted values of the speed of the vehicle 2 up to time t2 and the speed thereof from time t1 onwards. FIG. 4(C) shows a regenerative braking force F_{MG} produced by the braking torque generated by the motor generator 212 and a friction braking force F_{BK} generated by the right and left front friction brakes 231R and 231L.

According to the example shown in FIG. 4, the reverse rotation prediction unit 103 predicts how the rotation speed of the motor generator 212 changes from time t1 onwards by extrapolating it from the changes in the rotation speed of the motor generator 212 detected until time t1.

In step S103 after step S102, the reverse rotation prediction unit 103 predicts the speed of the vehicle 2. The reverse rotation prediction unit 103 predicts the speed of the vehicle 2 based on the detection results of the acceleration detection unit 101. According to the example shown in FIG. 4, the reverse rotation prediction unit 103 predicts how the speed of the vehicle 2 changes from time t1 onwards by extrapolating it from the change in speed based on the speed and acceleration of the vehicle 2 at time t1.

In step S104 after step S103, the reverse rotation prediction unit 103 determines whether the reverse rotation of the motor generator 212, which is an electric motor, will occur before the vehicle 2 stops. When it is determined that the reverse rotation of the motor generator 212 will occur, the process proceeds to step S105. When it is not determined that the reverse rotation of the motor generator 212 will occur, the process returns to the processing of step S101.

In step S105, the reverse rotation prediction unit 103 predicts the reverse rotation timing. According to the example shown in FIG. 4, the rotation speed of the motor generator 212 becomes 0 at time t3. On the other hand, the speed of the vehicle 2 is not 0 at time t3, but becomes 0 at time t4 after time t3. This means that, from time t3 onwards, the vehicle 2 is in a state in which it is traveling with a rotation speed of the motor generator 212 of 0. Therefore, the motor generator 212 rotates backward, and the right and left front wheels 215R and 215L also rotate backward. According to this example, the processing of steps S104 and S105 is performed at time t1, and it is predicted that the reverse rotation timing will arrive at time t3.

In step S106 after step S105, the friction braking unit 104 calculates the activation timing of the friction brakes. In the example shown in FIG. 4, calculating backward from time t3 which is the reverse rotation timing, time t2 is set as the activation timing of the friction brakes so that the friction braking force F_{BK} of the friction brakes is maximized at time t3. The motor control unit 121 starts reducing the regenerative braking force F_{MG} from time t2.

In step S107 after step S106, the friction braking unit 104 actuates the friction brakes at the timing calculated in step S106. In the example shown in FIG. 4, time t2 is that timing. The friction braking force F_{BK} is maximized at time t3, and the vehicle 2 stops at time t4. The motor control unit 121 starts reducing the regenerative braking force F_{MG} from time t2. When the processing of step S107 is finished, the process returns.

In the present embodiment, the braking control device is composed of the ESC-ECU 10 and the EV-ECU 12. The braking control device includes a motor control unit 121, an acceleration detection unit 101, a rotation speed detection unit 102, a reverse rotation prediction unit 103, and a friction braking unit 104. The motor control unit 121 performs control to generate a drive braking torque for providing a drive force or braking force from a motor generator 212, which is an electric motor connected to a drive wheel of a vehicle 2, to the drive wheel. The acceleration detection unit 101 detects an acceleration of the vehicle 2. The rotation speed detection unit 102 detects a rotation speed of the motor generator 212. The reverse rotation prediction unit 103 uses the acceleration detected by the acceleration detection unit 101 and the rotation speed detected by the rotation speed detection unit 102 to predict a reverse rotation timing at which the drive wheel will rotate backward before the vehicle 2 stops. The friction braking unit 104 controls a friction braking device provided for the drive wheel. The motor control unit 121 reduces the drive braking torque for applying the braking force to the drive wheel by the reverse rotation timing predicted by the reverse rotation prediction unit 103 at the latest. The friction braking unit 104 increases a friction braking force applied to the drive wheel by the friction braking device so that the friction braking force exceeds the braking force provided by the drive braking torque by the reverse rotation timing predicted by the reverse rotation prediction unit 103 at the latest.

In the present embodiment, since the reverse rotation prediction unit 103 predicts the reverse rotation timing based on the acceleration of the vehicle 2 and the rotation speed of the motor generator 212, the generation of the braking force by the motor generator 212 can be continued until a time that is no later than the reverse rotation timing and as close as possible to the reverse rotation timing, reflecting the influence of the road surface conditions. This contributes to securing a sufficient amount of regenerative power. Since the friction braking force is increased while reducing the braking force provided by the motor generator 212 so that the friction braking force exceeds the braking force provided by the motor generator 212 by the reverse rotation timing, the drive wheel can be braked without rotating backward regardless of the road surface conditions.

Further, in this embodiment, the motor control unit 121 may reduce the braking force provided by the motor generator 212 so as not to exceed a total braking force obtained by adding a vehicle braking force actually transmitted to a road surface to the friction braking force.

Since the braking force provided by the motor generator 212 is reduced so as not to exceed the total braking force, the braking force can be maintained higher compared to when the braking force is reduced so as not to exceed only the friction braking force, which makes it possible to secure a larger amount of regenerative power generated by the motor generator 212.

In this embodiment, when a plurality of drive wheels are provided, the friction braking unit 104 may increase the friction braking force for each of the plurality of drive wheels.

Since the friction braking force is increased for each drive wheel, even when the road surface conditions differ for each drive wheel, braking can be performed according to the conditions.

In this embodiment, the friction braking unit 104 may perform preparation for increasing the friction braking force prior to increasing the friction braking force.

By performing preparation for increasing the frictional braking force prior to increasing the frictional braking force, the increase responsiveness of the frictional braking force can be enhanced, which makes it possible to delay the timing at which the frictional braking force is delayed. By delaying the timing at which the friction braking force is increased, the timing at which the braking force provided by the motor generator 212 is reduced can be delayed, and thus a larger amount of regenerative power can be secured.

In the present embodiment, the friction braking unit 104 may perform the preparation for increasing the friction braking force by increasing a hydraulic pressure of a pressure boost source included in the friction braking device.

By increasing the hydraulic pressure of the pressure boost source, the preparation for increasing the friction braking force can be performed more reliably. The “pressure boost source” is a subsystem configured to be able to boost the brake fluid pressure in response to a signal output from the ECU. The pressure boost source may be a master cylinder that can be electrically driven. The pressure boost source may be a combination of a plurality of solenoid valves, an accumulator, and a pump controlled so that the pressure in the accumulator is always substantially constant. The pressure boost source may be a gear pump that is driven when it is necessary to boost the brake fluid pressure. The pressure boost source is not limited to these examples and can be any widely known pressure boost source as long as it is configured to be capable of boosting the brake fluid pressure.

In the present embodiment, the friction braking unit 104 may perform the preparation for increasing the friction braking force by reducing a distance between a brake pad included in the friction braking device and a member against which the brake pad is pressed.

By reducing the distance between the brake pad and the member against which the brake pad is pressed, the preparation for increasing the friction braking force can be performed more reliably.

In addition, in the present embodiment, the timing at which the friction braking force exceeds the braking force provided by the drive braking torque may be determined depending on a responsiveness of the friction braking device.

Since the response of the friction braking device is slower than the response of the motor generator 212, it is more preferable to determine the timing at which the friction braking force exceeds the braking force provided by the drive braking torque depending on the responsiveness of the friction braking device so that the reverse rotation of the drive wheel can be prevented with higher reliability.

Embodiments have been described with reference to specific examples. However, the present disclosure is not limited to these specific examples. Variations obtained by those skilled in the art making design changes to the specific examples as appropriate also fall within the scope of the present disclosure as long as they have the feature(s) of the present disclosure. The elements of the specific examples, their arrangement, conditions, shapes, and the like are not limited to those exemplified and can be changed as appropriate. The elements of the specific examples can be combined differently as long as there is no technical contradiction.

What is claimed is:

1. A braking control device comprising:
a motor control unit that causes an electric motor connected to a drive wheel of a vehicle to generate a drive braking torque for applying a drive force or braking force to the drive wheel;
an acceleration detection unit that detects an acceleration of the vehicle;
a rotation speed detection unit that detects a rotation speed of the electric motor;
a reverse rotation prediction unit that uses the acceleration detected by the acceleration detection unit and the rotation speed detected by the rotation speed detection unit to predict a reverse rotation timing at which the drive wheel will rotate backward before the vehicle stops; and
a friction braking unit that controls a friction braking device provided for the drive wheel, wherein:
the motor control unit reduces the drive braking torque for applying the braking force to the drive wheel by the reverse rotation timing predicted by the reverse rotation prediction unit at the latest; and
the friction braking unit increases a friction braking force applied to the drive wheel by the friction braking device so that the friction braking force exceeds the braking force provided by the drive braking torque by the reverse rotation timing predicted by the reverse rotation prediction unit at the latest.

2. The braking control device according to claim 1, wherein,
the motor control unit reduces the braking force provided by the electric motor so as not to exceed a total braking force obtained by adding a vehicle braking force actually transmitted to a road surface to the friction braking force.

3. The braking control device according to claim 1, wherein,
when a plurality of the drive wheels are provided, the friction braking unit increases the friction braking force for each of the plurality of drive wheels.

4. The braking control device according to claim 1, wherein,
the friction braking unit performs preparation for increasing the friction braking force prior to increasing the friction braking force.

5. The braking control device according to claim 4, wherein,
the friction braking unit performs the preparation for increasing the friction braking force by increasing a hydraulic pressure of a pressure boost source included in the friction braking device.

6. The braking control device according to claim 4, wherein,
the friction braking unit performs the preparation for increasing the friction braking force by reducing a distance between a brake pad included in the friction braking device and a member against which the brake pad is pressed.

7. The braking control device according to claim 1, wherein,
the timing at which the friction braking force exceeds the braking force provided by the drive braking torque is determined depending on a responsiveness of the friction braking device.
